(19) United States
(12) Patent Application Publication
(10) Pub. No.: US 2002/0168168 A1
(43) Pub. Date: Nov. 14, 2002

(54) Mounting an optical fibre to an optical chip

(75) Inventor: Ebrahim Iravani, Swindon (GB)

Correspondence Address: FULBRIGHT & JAWORSKI L.L.P., R. Ross Viguet, Suite 2800, 2200 Ross Avenue, Dallas, TX, 75201, US

(73) Assignee: Bookham Technology PLC, Abingdon (GB)

(21) Appl. No.: 10/117,443

(22) Filed: Apr. 5, 2002

(30) Foreign Application Priority Data
Apr. 6, 2001 (GB) 0108747.7

(51) Int. Cl. G02B 6/36

(52) U.S. Cl. 385/136; 385/137; 385/88

(57) ABSTRACT

In one aspect of the invention there is provided a retainer (150) for retaining a first section of an elongate element (13) of generally curvilinear cross section in a mounting channel (18) which extends along a surface (24) of a first side of a substrate (23) from an edge (25) at which a second side (27) of the substrate inclines away from the first side in a first direction. The retainer has a mounting surface (170) adapted in use to be mounted on the surface of the first side of the substrate, a first retaining channel (156) formed in the mounting surface adapted in use to cover the first section of the elongate element in the mounting channel, an overhanging surface (172) adapted in use to overhang the edge of the first side of the substrate, the overhanging surface being displaced, in use, in the first direction relative to the mounting surface, and a second retaining channel (156) formed in the overhanging surface adapted in use to be positioned about a second section of the elongate element which projects from the mounting channel. In another aspect of the invention there is provided a coupling device (11) for coupling an optical fibre (13) to a package (1) which has an indexing feature (34) adapted to co-operate with an indexing feature (37) on an optical fibre cleaving apparatus. In a further aspect there is provided a method of guiding an optical fibre (13) into a mounting channel (18) in a substrate (23) through use of a tapered guide channel (56) in a guide element (50). In a yet further aspect of the invention there is provided a substrate (223) for an optical chip having a side with a surface (224) in which there is formed a first channel (218) for an optical fibre (13) to be mounted in and a second channel (218a, 218b) which is oriented transversely to, and in communication with, the first channel.

### FIELD OF THE INVENTION

The present invention relates to improvements in mounting an optical fibre to an optical chip.

### BACKGROUND OF THE INVENTION

An optical chip may have one or more circuit elements which, for example, either produce photocurrent, emit light in response to an injection of electric current or multiplex or demultiplex light signals of different wavelengths. The optical chip may be housed in a package having pins for connecting at least some of the circuit elements to a printed circuit board. Such packages are made known in International patent application publication WO00/02079 (Bookham Technology Limited/Yeandle et al) and U.S. Pat. No. 6,0787,11 (Bookham Technology Plc/Yeandle et al) and act to provide electrical and environmental shielding for the optical chip. One or more optical fibres extend into the package and are mounted to the optical chip to transmit light to, or from, the circuit element(s).

Typically, the optical chip has a silicon substrate on a surface of which the or each circuit element is formed together with one or more optical waveguides for coupling the circuit element(s) to the optical fibre(s). Invariably, the silicon substrate is mounted on an insulator.

One example of an optical chip is an optical transceiver in which a laser diode and a photodiode are on the substrate surface together with associated waveguides. Optical transceivers are used for bi-directional communication in access network applications, such as fibre to the kerb or fibre to the cabinet in telecommunications networks, and are designed to work over a temperature range of −40° C. to 85° C. thereby making them suitable for applications in uncontrolled environments.

It is known in the art to couple an optical fibre to an optical waveguide (or other circuit element) by mounting the optical fibre in a channel extending from an edge of the substrate surface to the waveguide. The mounting channel may be etched, for instance by wet etching with a chemical etchant. When a channel is wet etched in a silicon substrate, the channel has a V-shaped cross section and an end face which slopes away from the edge. This is due to the etching occurring along specific crystallographic planes of the substrate material. The V-shape may have a flat bottom surface depending on the depth of the etch.

The inclined end face of the channel leads to the optical fibre being spaced farther from the waveguide than is optimal for optical coupling. To address this problem, U.S. Pat. No. 5,7872,14 (Bookham Technology Limited/Harpin et al) teaches a method of forming the channel so that the end of the waveguide overhangs the inclined end face of the channel to form a so-called “diving board”. The diving board arrangement allows the ends of the optical fibre and waveguide to be more closely apposed.

It is the convention to secure the optical fibre in the V-shaped channel with an adhesive or solder. While this provides the optical fibre with resistance to axial withdrawal forces, the optical fibre is not securely held against forces tending to peel the fibre out of the channel in a direction transverse to the fibre axis. To address this, it has been proposed to hold the optical fibre in the V-shaped channel by means of a mechanical constraint or retainer, for example by sandwiching the optical fibre between the constraint and the V-shaped channel. The mechanical constraint may or may not be affixed to the surface of the substrate or the insulator. While such a mechanical constraint alleviates the problem of peel-out of the optical fibre, it suffers the drawback of requiring accurate alignment of the constraint to ensure that it holds the optical fibre without damaging or deforming it.

In U.S. Pat. No. 6,0787,11 supra there is made known a retainer which is affixed by adhesive or solder to the edge of the substrate surface about the entrance to the channel. In one embodiment, the retainer has an aperture through which the optical fibre projects into the channel. In another embodiment, the retainer, when affixed to the edge, has an inverted U-shape so that the edge of the substrate and the inner surface of the legs and the base of the retainer define an aperture through which the optical fibre projects into the channel. While these retainers resist peeling movement of the optical fibre, placing the retainer is operator dependent and a timely procedure. The retainer also easily picks up dirt when it is examined to ensure that it is placed on the fibre the right way round. Moreover, the retainer often does not sit square against the substrate and it is important to have the correct amount of adhesive. If too much adhesive is used, this can overflow into the V-shaped channel on the substrate surface and break the diving board on thermal expansion of the optical fibre. The optical fibre also tends not to lie flat and straight in the V-shaped channel unless this form of retainer is used correctly, which is difficult.

The package made known in WO00/02079 supra has a passageway which extends from an opening in the casing of the package to a cavity defined in the package for housing the optical chip. A ferrule is secured in the passageway and the optical fibre(s) projects into the cavity for mounting to the optical chip through the ferrule. Coupling of the optical fibre to the package in this manner allows a hermetic seal to be formed in the passageway for the optical fibre. As an example, the ferrule is secured to the passageway wall through an adhesive or solder so as to seal off the annulus therebetween. Moreover, a sealing insert can be provided in the ferrule so as to seal between the optical fibre and the ferrule, as disclosed in WO00/02079. The optical fibre is cleaved to length after being pushed through the ferrule but prior to the ferrule being secured in the package passageway. A problem with the ferrules hitherto used to couple an optical fibre to a package is that the orientation of the cleaved optical fibre projecting from the ferrule is not indexed to the ferrule. Accordingly, it is difficult to detect whether the placing of the ferrule in the passageway gives the correct orientation of the optical fibre for mounting to the optical chip.

As outlined in GB-A-2340620 (Bookham Technology Limited/Yeandle et al), it is preferable for the chip substrate to be arranged in the cavity of the package so that the optical fibre enters the cavity from the ferrule in a plane which is spaced vertically above the plane of the substrate surface. This ensures that the optical fibre adopts a S-bend between the substrate and the ferrule when fixed in the V-shaped substrate channel, i.e. between the fixing points of the optical fibre. The different coefficients of thermal expansion of the components of the package results in axial displacement of the ferrule relative to the substrate on temperature cycling. Accordingly, the section of optical fibre between the ferrule and substrate is subject to longitudinal displacement, and the mounting of the optical fibre in the V-shaped channel in the substrate surface is subject to tensile or compressive stress depending on the direction of longitudinal displacement. The provision of the S-bend enables the optical fibre to accommodate such longitudinal displacement so that the tensile or compressive forces experienced at the fixing points are maintained substantially constant. Moreover, while a small additional strain is induced in the optical fibre by the S-bend, the S-bend controls the maximum strain in the optical fibre on axial displacement of the ferrule relative to the substrate. In this way, the mounting of the optical fibre to the substrate is rendered relatively insensitive to temperature fluctuations.

It is an aim of the present invention to provide improvements to the way in which an optical fibre is mounted to an optical chip.

### SUMMARY OF THE INVENTION

According to a first aspect of the invention there is provided a retainer for retaining a first section of an elongate element of generally curvilinear cross section in a mounting channel which extends along a surface of a first side of a substrate from an edge at which a second side of the substrate inclines away from the first side in a first direction, the retainer having:

a mounting surface adapted in use to be mounted on the surface of the first side of the substrate;

a first retaining channel formed in the mounting surface adapted in use to cover the first section of the elongate element in the mounting channel;

an overhanging surface adapted in use to overhang the edge of the first side of the substrate, the overhanging surface being displaced, in use, in the first direction relative to the mounting surface; and

a second retaining channel formed in the overhanging surface adapted in use to be positioned about a second section of the elongate element which projects from the mounting channel.

According to a second aspect of the invention there is provided a retainer for retaining a first section of an elongate element of generally curvilinear cross section in a mounting channel which extends along a surface of a first side of a substrate from an edge at which a second side of the substrate inclines away from the first side in a first direction, the retainer having:

a mounting surface adapted in use to be mounted on the surface of the first side of the substrate;

a first retaining channel having a first width formed in the mounting surface adapted in use to cover the first section of the elongate element in the mounting channel;

an overhanging surface adapted in use to overhang the edge of the first side of the substrate, the overhanging surface being displaced, in use, in the first direction relative to the mounting surface; and

a second retaining channel formed in the overhanging surface adapted in use to be positioned about a second section of the elongate element which projects from the mounting channel, the second channel having a second width greater than the first width and tapered sidewalls which, in use, diverge in the first direction.

In one embodiment of the invention the retainer has a first side of which the mounting and overhanging surfaces form sections and a second side at an edge of the first side, the section of the first side formed by the overhanging surface and the second retaining channel extending inwardly from the edge of the first side of the retainer. The first and second retaining channels may form sections of a channel which extends along the surface of the first side of the retainer from the edge thereof.

In another embodiment of the invention the retainer has a first side of which the mounting and overhanging surfaces form sections and a second side at an edge of the first side, the first and second retaining channels forming sections of a channel which extends along the first side of the retainer from the edge thereof.

In a further embodiment of the invention the mounting and overhanging surfaces form contiguous sections of a side of the retainer. Alternately, the mounting and overhanging surfaces form discrete sections of a side of the retainer.

Preferably, the edge of the first side of the retainer is a first edge, the first side of the retainer has a second edge between the first side and a third side and the channel extends from the first edge to the second edge.

Preferably, the section of the first side of the retainer formed by the mounting surface extends inwardly from the second edge.

Preferably, the channel in the first side of the retainer consists of the first and second retaining channels.

Preferably, the first and second retaining channels have tapered sidewalls which, in use, diverge in the first direction. More preferably, the tapered sidewalls are connected by a base wall which extends laterally to the sidewalls. The first and second retaining channels may have a V-shaped or curvilinear cross section.

Preferably, the retainer is formed from a material which is transparent to ultraviolet radiation. As an example, ceramics such as macor and alumina may be used. Alternately, plastics materials may be used, for instance an acrylic material such as polymethyl methacrylate, e.g. Perspex™.

According to a third aspect of the invention there is provided an assembly comprising a substrate having a first side with a surface in which is formed a mounting channel which extends from an edge at which a second side of the substrate is inclined away from the first side in a first direction, an elongate element of generally curvilinear cross section having a first section disposed in the mounting channel and a second section projecting from the mounting channel, and a retainer according to the first or second aspect of the invention, the mounting surface of the retainer being apposed to the first side of the substrate so that the first section of the elongate member is covered by the first retaining channel with the overhanging surface of the retainer overhanging the edge of the first side of the substrate and being displaced in the first direction relative to the mounting surface with the second retaining channel being disposed about the second section of the elongate element.

The elongate member may be an optical fibre and the substrate a part of an optical chip.

Preferably, the mounting channel has tapered sidewalls which converge in the first direction. More preferably, the tapered sidewalls of the mounting channel are bridged by a base wall which extends laterally to the tapered sidewalls.

Preferably, the width of at least the second retaining channel is greater than the width of the mounting channel. More preferably, the base wall of at least the second retaining channel has a width which is greater than the width of the mounting channel.

According to a fourth aspect of the invention there is provided a method of guiding an optical fibre into a mounting channel which extends along a surface of an optical chip, the method comprising the steps of:

providing a guide element having a surface in which there is formed a guide channel having tapered sidewalls;

positioning the guide element, the optical chip and the optical fibre relative to one another such that the guide channel faces the mounting channel with the optical fibre disposed between the surfaces of the guide element and the optical chip; and

effecting relative displacement between the guide element and the optical chip so that the optical fibre is guided into the mounting channel by the guide channel.

Preferably, the guide channel has a width which is greater than that of the mounting channel. More preferably, the guide channel has a base wall which bridges the tapered sidewalls with the width of the base wall being greater than the width of the mounting channel.

Preferably, the guide element, the optical chip and the optical fibre are positioned relative to one another such that the optical fibre is positioned on an axial path between the guide channel and the mounting channel and the relative displacement between the guide element and the optical chip is along the axial path. The relative positioning of the guide element, the optical chip and the optical fibre may be such that the guide channel and mounting channel are in registration with one another.

Preferably, the relative positioning of the guide element, the optical chip and the optical fibre is such that at least a part of the base wall of the guide channel overlaps the mounting channel whereby when the optical fibre is positioned in the mounting channel it is acted on by the base wall of the guide channel.

Preferably, the relative movement between the guide element and the optical chip results in at least a section of the surface of the guide element being brought into apposition with the surface of the optical chip. More preferably, a mounting section of the surface of the guide element is brought in apposition with the surface of the optical chip while an overhanging section of the surface of the guide element overhangs the surface of the optical chip. The overhanging section may be displaced relative to the mounting section in the direction of movement of the guide element relative to the optical chip.

Preferably, the mounting channel has a depth in a first direction, the surface of the optical chip is of a first side and the mounting channel extends along the surface of the first side from an edge at which a second side of the optical chip is inclined away from the first side in the first direction.

Correspondingly, the guide channel may have a depth in a second direction with the surface of the guide element being of a first side and the guide channel extending along the surface of the first side from an edge at which a second side of the guide element is inclined away from the first side in the second direction. Preferably, the guide channel extends from the edge between the first and second sides to an edge between the first side and a third side which is inclined away from the first side in the second direction.

Accordingly, when the overhanging section of the surface of the guide element is displaced relative to the mounting section, the direction of displacement is opposite to the second direction. Consequently, relative displacement between the guide element and the optical chip results in the overhanging section overhanging the edge between the first and second sides of the optical chip.

According to a fifth aspect of the present invention there is provided a method of guiding an elongate element of generally curvilinear cross section into a mounting channel which extends along a surface of a first side of a substrate from an edge at which a second side of the substrate inclines away from the first side in a first direction comprising the steps of:

providing a retainer according to the first aspect of the invention in which at least the second retaining channel has tapered sidewalls and the mounting and overhanging surfaces form mounting and overhanging sections of a side of the retainer;

positioning the retainer, the substrate and the elongate element relative to one another such that the first and second retaining channels face the mounting channel with the elongate element disposed between the side of the retainer and the first side of the substrate; and

effecting relative displacement between the retainer and the substrate so that the elongate element is positioned in the mounting channel with:

the mounting section apposed to the first side of the substrate,

the overhanging section overhanging the edge between the first and second sides of the substrate, and

the first and second retaining channels covering the elongate element.

According to a sixth aspect of the present invention there is provided a method of guiding an elongate element of generally curvilinear cross section into a mounting channel which extends along a surface of a first side of a substrate from an edge at which a second side of the substrate inclines away from the first side in a first direction comprising the steps of:

providing a retainer according to the second aspect of the invention in which the mounting and overhanging surfaces form mounting and overhanging sections of a side of the retainer;

positioning the retainer, the substrate and the elongate element relative to one another such that the first and second retaining channels face the mounting channel with the elongate element disposed between the side of the retainer and the first side of the substrate; and

effecting relative displacement between the retainer and the substrate so that the elongate element is positioned in the mounting channel with:

the mounting section apposed to the first side of the substrate,

the overhanging section overhanging the edge between the first and second sides of the substrate, and

the first and second retaining channels covering the elongate element.

Preferably, the retainer, the substrate and the elongate element are positioned relative to one another such that the elongate element is positioned on an axial path between the first and second retaining channels and the mounting channel and the relative displacement between the retainer and the substrate is along the axial path. The relative positioning of the retainer, the substrate and the elongate element may be such that the first and second retaining channels are in registration with the mounting channel.

Preferably, the relative positioning of the retainer, the substrate and the elongate element is such that at least a part of a base wall of the first and second retaining channels, which extends laterally to the tapered sidewalls, overlaps the mounting channel whereby when the elongate element is positioned in the mounting channel it is acted on by the base wall of the first and second retaining channels.

According to a seventh aspect of the invention there is provided a coupling device for coupling an optical fibre to a package for mounting of the optical fibre to an optical chip in the package, the coupling device having:

a body which:

is adapted to be coupled to the package in a coupled position;

has a passageway in which the optical fibre is positionable in a secured position such that a section of the optical fibre projects from the passageway; and

is provided with an indexing feature adapted to co-operate with an indexing feature of an apparatus for cleaving optical fibre whereby cleavage of the section of the optical fibre projecting from the passageway by the apparatus when the respective index features co-operate indexes the length and orientation of the cleaved optical fibre section to the indexing feature on the coupling device.

Preferably, the passageway is an open-ended passageway through which the optical fibre is passable to the secured position.

According to an eighth aspect of the invention there is provided a coupling device according to the seventh aspect of the invention in combination with an apparatus for cleaving optical fibre having an indexing feature co-operable with the indexing feature of the coupling device.

Preferably, the indexing feature on the coupling device is a structural feature adapted to engage with the indexing feature on the cleaving apparatus. As an example, the indexing feature on the coupling device may be a recess or a protrusion for engaging with a complementary structure on the cleaving apparatus.

Alternately, the indexing feature on the coupling device may be an alignment mark.

According to a ninth aspect of the invention there is provided a substrate for an optical chip having a side with a surface in which there is formed a first channel for an optical fibre to be mounted in and a second channel which is oriented transversely to, and in communication with, the first channel.

Preferably, the first channel has an end and the second channel is located at, or adjacent to, the end.

Preferably, the surface is provided with a third channel oriented transversely to, and in communication with, the first channel and the second and third channels are aligned with one another on opposing sides of the first channel.

Preferably, the first channel extends into the surface from an edge of the side.

According to an tenth aspect of the invention there is provided an optical chip having a substrate according to the ninth aspect of the invention.

According to an eleventh aspect of the present invention there is provided a retainer for retaining a flexible elongate element of generally curvilinear cross section in a mounting channel extending along an upper surface of a substrate, the retainer having a lower surface along which a retaining channel extends in a forward direction from a rear edge of the lower surface, wherein, in use, the lower surface is juxtaposed with the substrate upper surface to retain the elongate element in the mounting channel and to align the respective channels, wherein the elongate element is receivable upwardly into the retaining channel to rest on a contact area which, at the rear edge, is spaced upward of the lower surface at a first level and extends downwardly from the rear edge towards the lower surface in the forward direction whereby, in use, the elongate element is able to be angled upwardly from the mounting channel through the retaining channel. The retainer has particular application for retaining an optical fibre in a substrate mounting channel and enabling the optical fibre to adopt a S-bend configuration of the type advocated in GB-A-2340620 supra.

The sloping contact area may extend downwardly in planar fashion, arcuately or in incremental steps, for example. If arcuate, it is preferably a convex arc. Preferably, the contact area extends downwardly towards the lower surface monotonically.

Preferably, the retaining channel has sidewalls which converge from the lower surface in the upward direction. The convergent sidewalls are advantageous when the retainer is also used to displace the elongate element into the mounting channel, since the sidewalls act to centre the elongate element.

The contact area of the retaining channel is preferably its bottom. This simplifies manufacture of the retainer as the tolerances are reduced, for instance compared to the case where the contact area is selected to be on the convergent sidewalls, particularly when the retaining channel is formed by etching. The bottom of the retaining channel may be a planar surface.

Preferably, the retaining channel is a rear section of a retaining channel structure further comprising a forward section which, in use, is co-extensive with the mounting channel, wherein the forward section has a contact area for the elongate element spaced upwardly from the lower surface at a second level which is spaced downwardly relative to the first level, and wherein the rear section extends forwardly from the rear edge to a forward position at which the contact area is spaced upwardly from the lower surface at a third level which is spaced downwardly relative to the first level no lower than the second level. In this case, the forward section would act to retain the elongate element in the mounting channel with the rear section providing the elongate element with the ability to flex or bend upwardly, e.g. to adopt a S-bend as preferred in optical fibre packages.

Preferably, the second and third levels are at the same level.

Preferably, the forward and rear sections are contiguous at the forward position.

The contact area of the forward section may also be its bottom.

The forward section preferably has sidewalls which converge from the lower surface in the upward direction. The provision of such sidewalls in the forward section again enables the retainer to be used to accurately locate the elongate element in the mounting channel

The retaining channel may have parallel sidewalls extending downwardly from its bottom to give a generally U-shaped cross section. The convergent sidewalls may then be lower sidewalls and the parallel sidewalls contiguous upper sidewalls to give the retaining channel a funnel-like cross section.

Preferably, the rear section has a lower portion extending upwardly from the lower surface to a level located upwardly of the second level and the lower portion has a minimum lateral width which is at least equal to a lateral width of the forward section at the lower surface. The rear section may have a minimum lateral width which is at least equal to a lateral width of the forward section at the lower surface. The minimum lateral width of the rear section may be at its bottom.

Preferably, the rear and forward sections of the retainer channel structure are respectively formed in rear and forward sections of the lower surface, the rear section of the lower surface being displaced downwardly relative to the forward section of the lower surface whereby, in use, the forward section of the lower surface is juxtaposed with the substrate upper surface with the rear section of the lower surface overhanging the substrate upper surface. Ideally, the rear and forward sections of the lower surface are contiguous.

The lower surface may have a forward edge and the retaining channel structure extends from the rear edge to the forward edge. The forward section of the lower surface may extend rearwardly from the forward edge.

Preferably, the retaining channel structure consists of the rear and forward sections.

Preferably, the retainer is formed from a material which is transparent to ultraviolet radiation. This proves useful when an ultraviolet radiation curable adhesive is to be used to adhere the retainer and/or the elongate element to the substrate.

In a twelfth aspect of the present invention there is provided an assembly comprising a substrate having an upper surface with rear and forward edges in which is formed a mounting channel having a forward end and a rear end, an elongate element of generally curvilinear cross section having a forward section disposed in the mounting channel and a rear section projecting rearwardly from the mounting channel, and a retainer having a lower surface with rear and forward edges in which a retaining channel extends forwardly from the rear edge, the retainer being arranged relative to the substrate so that the lower surface thereof is juxtaposed with the substrate upper surface to cover the mounting channel to retain the forward section of the elongate element therein and that the rear section of the elongate element projects rearwardly upwardly from the mounting channel through the retaining channel.

Preferably, the retaining channel is a rear section of a retaining channel structure which further has a forward section which overlies the forward section of the elongate element. The forward and rear sections of the retaining channel structure may each have a bottom at a level spaced upwardly from the lower surface with the bottom of the forward section being at a lower level relative to the level of the bottom of the rear section.

The retainer of the assembly may be a retainer according to the eleventh aspect of the invention.

The elongate element may be an optical fibre and the substrate a substrate of an optical chip.

The mounting channel may extend forwardly from the rear edge of the upper surface of the substrate.

Preferably, the rear edge of the lower surface of the retainer overhangs the rear edge of the upper surface of the substrate.

The assembly may further comprise a package having an outer casing, an interior cavity and an inlet through the outer casing to the interior cavity, wherein the substrate is located in the interior cavity such that the upper surface thereof is located downwardly relative to the inlet and wherein the elongate element projects through the inlet.

The aspects of the invention can be combined with each other or with selected features from the other aspects, in particular the aspects relating to a retainer.

By way of example, embodiments of the invention will now be described with reference to the accompanying Figures of drawings.

### BRIEF DESCRIPTION OF THE DRAWINGS

FIG. 1 is a schematic perspective view of a base of a package housing an optical chip;

FIG. 2 is a schematic cross sectional side view of the base of the package;

FIG. 3 is a schematic side view of an optical fibre mounted in a V-shaped groove in a silicon substrate of the optical chip;

FIG. 4 is an enlarged plan view of the optical fibre mounted in the V-shaped groove;

FIG. 5 is a cross sectional side view of the optical fibre mounted in the V-shaped groove;

FIG. 6 is an end view of a ferrule in accordance with the invention used to couple the optical fibre to the package base;

FIG. 7 is a side view of the ferrule;

FIG. 8 is a side view of the ferrule with the optical fibre projecting therefrom for cleavage by a cleaving element of a cleaving apparatus;

FIG. 9 is a schematic isometric view of a first retainer mounted to the substrate to retain the optical fibre in the V-shaped groove;

FIGS. 10 and 10A are views illustrating use of the first retainer to guide the optical fibre into the V-shaped groove of the substrate in accordance with the invention;

FIG. 11 is a front view of the first retainer mounted to the substrate;

FIG. 12 is a schematic isometric view of a cartridge of the first retainers;

FIG. 13 is a schematic isometric view of a second retainer in accordance with the invention mounted to the substrate to retain the optical fibre in the V-shaped groove;

FIG. 14 is a schematic isometric view of the second retainer;

FIGS. 15A-15C are front views of the second retainer guiding the optical fibre into the V-shaped groove on the substrate;

FIG. 16 is a further schematic isometric view of the second retainer mounted to the substrate;

FIG. 17 is a side view of the second retainer mounted to the substrate;

FIG. 18 is a further side view of the second retainer mounted to the substrate;

FIG. 19 is a schematic isometric view of a third retainer mounted to the substrate to retain the optical fibre in the V-shaped groove;

FIG. 19A is a side view of the third retainer mounted to the substrate with the third retainer shown in section;

FIGS. 20 and 20A are views illustrating use of the third retainer to guide the optical fibre into the V-shaped groove of the substrate;

FIG. 21 is a front view of the third retainer mounted to the substrate;

FIG. 22 is a schematic isometric view of a cartridge of the third retainers;

FIG. 23 is a schematic isometric view of a fourth retainer in accordance with the invention mounted to the substrate to retain the optical fibre in the V-shaped groove;

FIG. 24 is a schematic isometric view of the fourth retainer;

FIGS. 25A-25C are front views of the fourth retainer guiding the optical fibre into the V-shaped groove on the substrate;

FIG. 26 is a further schematic isometric view of the fourth retainer mounted to the substrate;

FIG. 27 is a side view of the fourth retainer mounted to the substrate;

FIG. 28 is a further side view of the fourth retainer mounted to the substrate; and

FIG. 29 is an enlarged plan view of a V-shaped groove in a substrate of an optical chip in accordance with the invention.

### DETAILED DESCRIPTION OF THE EXEMPLARY EMBODIMENTS OF THE INVENTION

In the following description of exemplary embodiments of the invention, like reference numerals are used to identify like features in the different embodiments.

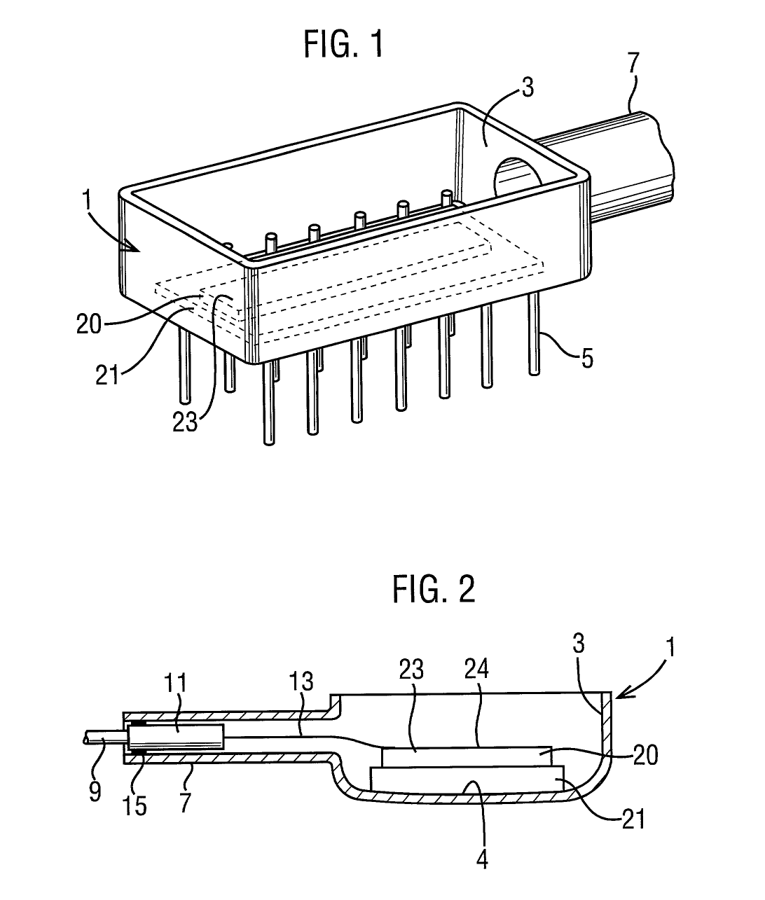

In FIGS. 1 and 2 there is shown a base 1 of a package for an integrated optical chip 20 having a silicon substrate 23 on which are formed opto-electronic circuit elements and associated waveguides (not shown). The base 1 has a recess 3, to the floor 4 of which the optical chip 20 is coupled through a ceramic insulator 21, and includes electrically conducting pins 5 to electrically connect one or more of the opto-electronic circuit elements to a printed circuit board. The base 1 also has a tubular extension 7 to which an optical fibre cable 9 is coupled through a ferrule 11. Although not shown, the package further includes a lid to cover the recess 3. The package acts to provide electrical shielding and hermetic sealing for the optical chip 20. To these ends, the package may be formed from Kovar™, an alloy of nickel (Ni), cobalt (Co) and iron (Fe).

As shown more particularly in FIG. 2, the ferrule 11 is secured to the inner surface of the tubular extension 7 through an adhesive, soldering or a glass seal 15. The optical fibre cable 9 is in turn secured in position in the ferrule 11, for example through use of an insert as detailed in WO00/02079 supra, the contents of which are hereby incorporated by reference.

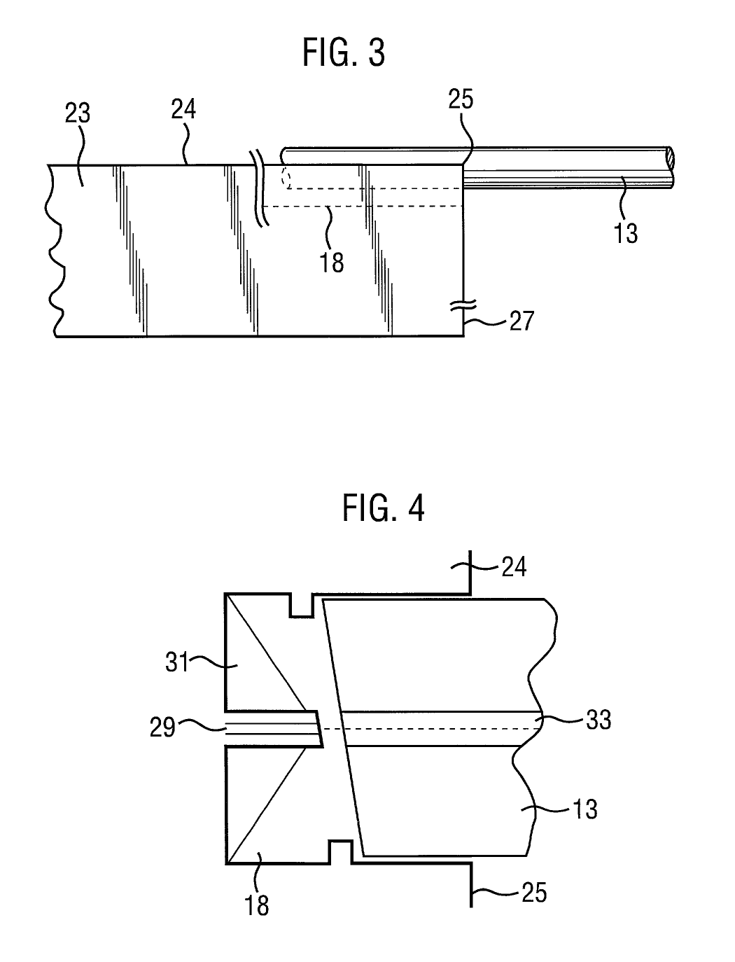

Referring to FIGS. 2 to 5, an optical fibre 13 extends from the ferrule 11 and is mounted in a groove 18 having a uniform V-shaped cross section which extends along an upper surface 24 of the substrate 23 from an edge 25 between the upper surface 24 and a side surface 27. As detailed in WO00/02079, the portion of the optical fibre 13 projecting from the ferrule 11 and mounted in the V-shaped groove 18 is stripped of its protective plastics outer coating.

As shown in FIG. 2, the upper surface 24 of the substrate 23 is located below the axis of the ferrule 11 whereby the optical fibre 13 adopts a S-bend configuration between the ferrule 11 and the substrate 23. As detailed in GB-A-2340620 supra, the contents of which are hereby incorporated by reference, the S-bend configuration is provided to compensate for the different coefficients of thermal expansion of the ferrule 11 and package casing. The S-bend allows the optical fibre 11 to accommodate the positive and negative longitudinal displacements of the ferrule 11 on temperature cycling of the package 1 without the fixing of the optical fibre 13 to the ferrule 11 and V-shaped groove 18 being over-stressed.

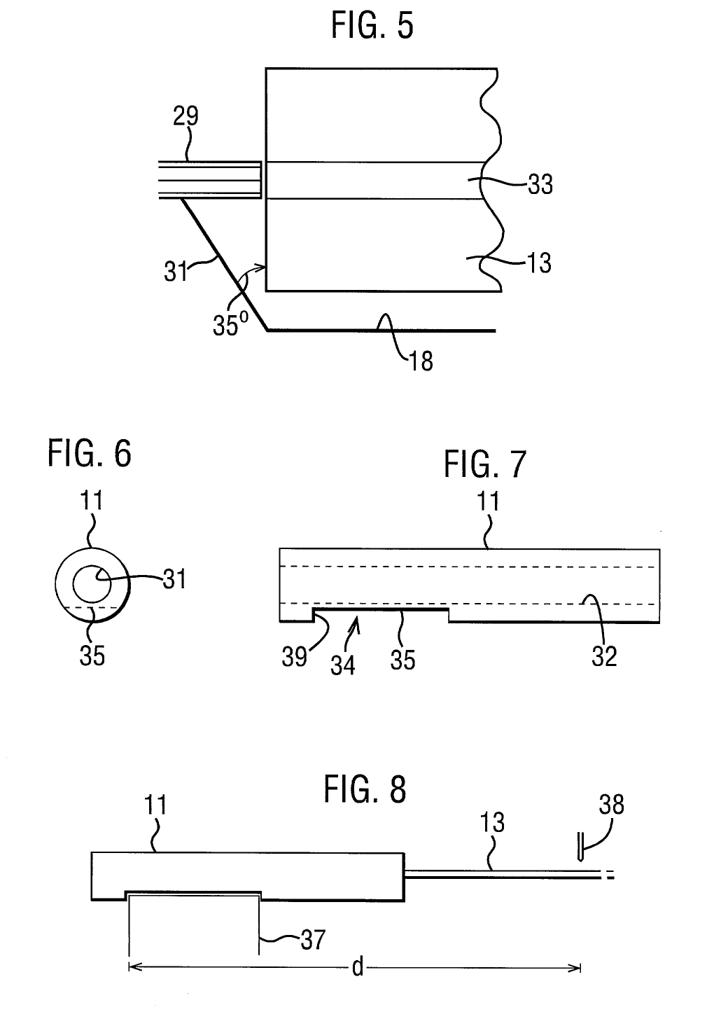

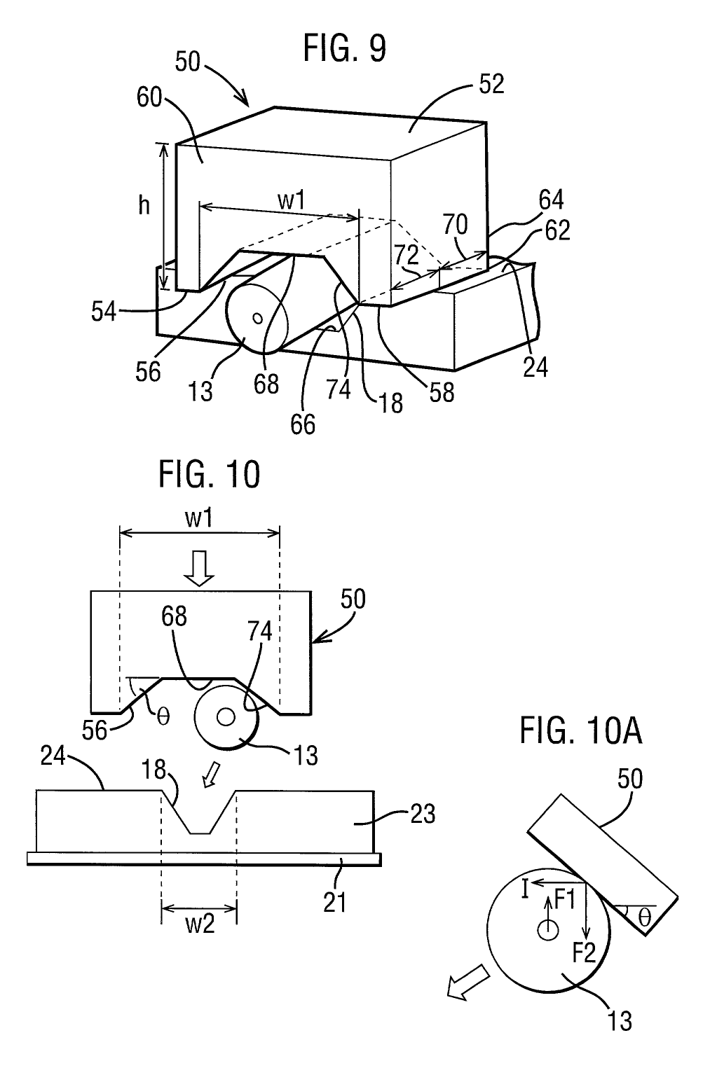

Turning to FIGS. 4 and 5, as detailed in U.S. Pat. No. 5,7872,14 supra, the contents of which are hereby incorporated by reference, the V-shaped groove 18 is formed in the substrate 23 by etching so that the end of a waveguide 29 which communicates with one or more opto-electronic circuit elements on the substrate 23 overhangs an end face 31 of the V-shaped groove 18. The V-shaped groove 18 has a depth to a base surface 66 (FIG. 9) of substantially 50-100 μm, preferably substantially 80-100 μm, and a width of substantially 140-150 μm at the upper surface 24, preferably substantially 143-146 μm.

As will be understood by particular reference to FIG. 5, this “diving board” arrangement allows a core 33 of the optical fibre 13 to be more closely apposed to the waveguide 29 than would otherwise be the case as the end face 31 is inclined due to the etching occurring along specific crystallographic planes of the silicon substrate material. The stripped optical fibre 13 has a diameter in the range of substantially 100-150 μm, preferably substantially 125 μm, with the core 33 having a diameter in the range of substantially 5 to 10 μm.

In FIGS. 6 to 8 the ferrule 11 used to couple the optical fibre 13 to the tubular extension 7 of the base 1 of FIGS. 1 and 2 is shown in more detail. The ferrule 11 is preferably made from brass with a gold coating and has a bore 32 through which the optical fibre 13 is able to pass and be retained in, for example through adhesive or an insert of the type described in WO00/02079 supra. The casing of the ferrule 11 is formed with a female recess 34 having a flat surface 35. As shown in FIG. 8, the female recess 34 is adapted to engage with a complementary male protrusion 37 on a jig of a cleaving apparatus to hold the ferrule 11 and the optical fibre 13 in a fixed position during cleavage of the optical fibre 13 by a cleaving element 38 such as mechanical cleaver or a laser cleaver. The particular type of cleaving apparatus used is not important, as will be understood by the skilled person in the art. One type of mechanical cleaver is the FK12 angled fibre cleaver (York Technologies Limited) whilst laser cleavers are available from Optek or AEA Technology.

Thus, the female recess 34 acts as an indexing feature for the cleave angle of the optical fibre 13. Accordingly, when the ferrule 11 and the optical fibre 13 are inserted into the tubular extension 7 of the base 1 of the package the orientation of the cleave angle is known whereby the optical fibre 13 can be oriented by the ferrule 11 to the optimal angular disposition for coupling of the optical fibre end with the waveguide 29. Moreover, the female recess 34 ensures that the optical fibre 13 is cleaved at the same position each time. In other words, the female recess 34 further acts as an indexing feature for the length of the optical fibre 13 projecting from the bore 32 of the ferrule 11, e.g. the distance d of the cleaved end of the optical fibre 13 from a back face 39 of the female recess 34 is known by preselecting the distance between the male protrusion 37 and the cleaving element 38.

It follows that the position of the cleaved end of the optical fibre 13 relative to the waveguide 29 can be accurately gauged as the ferrule 11 is inserted into the tubular extension 7 of the base 1 thereby preventing the waveguide 29 from being damaged by over insertion of the optical fibre 13. Moreover, the cleaved end of the optical fibre 13 is able to be positioned optimally with respect to the waveguide 29 to account for thermal expansion. To this end, the tubular extension 7 may be provided with an indexing feature for the female recess 34 to co-operate with, such as an alignment mark or a male protrusion, to indicate the correct orientation and positioning of the optical fibre 13 in the V-shaped groove 18.

In FIG. 9 there is shown a retainer 50 for retaining the optical fibre 13 in the V-shaped groove 18 in the silicon substrate 23. The retainer 50 is in the form of a lock 52 having an underside 54 in the surface of which is formed a groove 56 having a uniform V-shaped cross section. The V-shaped groove 56 extends from an edge 58 between the underside 54 and a first side 60 and an opposed edge 62 between the underside 54 and a second side 64. The V-shaped grooves 18, 56 of the silicon substrate 23 and the retainer 50 have base surfaces 66, 68 respectively.

A first section 70 of the surface of the underside 54 is secured to the upper surface 24 of the silicon substrate 23 so that the respective V-shaped grooves 18, 56 are in registration with one another with the optical fibre 13 captured therebetween. A second section 72 of the surface of the underside 54 overhangs the upper surface 24 of the silicon substrate 23.

The retainer 50 acts to oppose forces which tend to peel the optical fibre 13 out of the V-shaped groove 18 in the silicon substrate 23. Moreover, it is easier to place on the silicon substrate 23 than, for example, the retainer made known in U.S. Pat. No. 6,0787,11 supra.

Furthermore, in accordance with the present invention the retainer 50 can be used to guide the optical fibre 13 into the V-shaped groove 18 in the silicon substrate 23. When the ferrule 11 is secured in the tubular extension 7 of the package base 1 of FIG. 1, the optical fibre 13 is disposed above the upper surface 24 of the substrate 23, e.g. by 250 μm. Referring to FIGS. 10 and 10A, as a pick-and-place machine (not shown) lowers the retainer 50 with the V-shaped groove 56 facing towards the upper surface 24 of the substrate 23, the optical fibre 13 is collected in the V-shaped groove 56 of the retainer 50. Moreover, if the optical fibre 13 is not aligned with the V-shaped groove 18 of the substrate 23, the tapered walls 74 of the V-shaped groove 56 of the retainer 50 displace the optical fibre 13 inwardly in the direction of arrow I as the retainer 50 is lowered due to the optical fibre 13 experiencing an upward reaction force F1 opposing the downward force F2 exerted on it by the retainer 50. This situation is illustrated schematically in FIG. 10A. Continued downward movement of the retainer 50 results in the optical fibre 13 being guided into the V-shaped groove 18 on the substrate 23, the V-shape of the groove 56 of the retainer 50 acting to reduce the risk of the optical fibre 13 being clamped between the upper surface 24 of the substrate 23 and the retainer 50.

Pick-and-place machines are well known to those skilled in the art. For instance, they are widely used in the conventional electronics field. One such machine is the Micron 2 available from ESEC (ZEVATECH). Typically, the pick-and-place machine would have a vacuum tool to hold and move the retainer 50 and a load sensor to sense when the retainer 50 contacts the upper surface 24 of the substrate 23, or adhesive located thereon, and to stop further movement of the retainer 50.

As shown in FIG. 10, the width w1 of the V-shaped groove 56 of the retainer 50 is preferably greater than the width w2 of the V-shaped groove 18 in the substrate 23. This provides for greater tolerances in the positioning of the optical fibre 13 relative to the V-shaped groove 18 in the substrate upper surface 24.

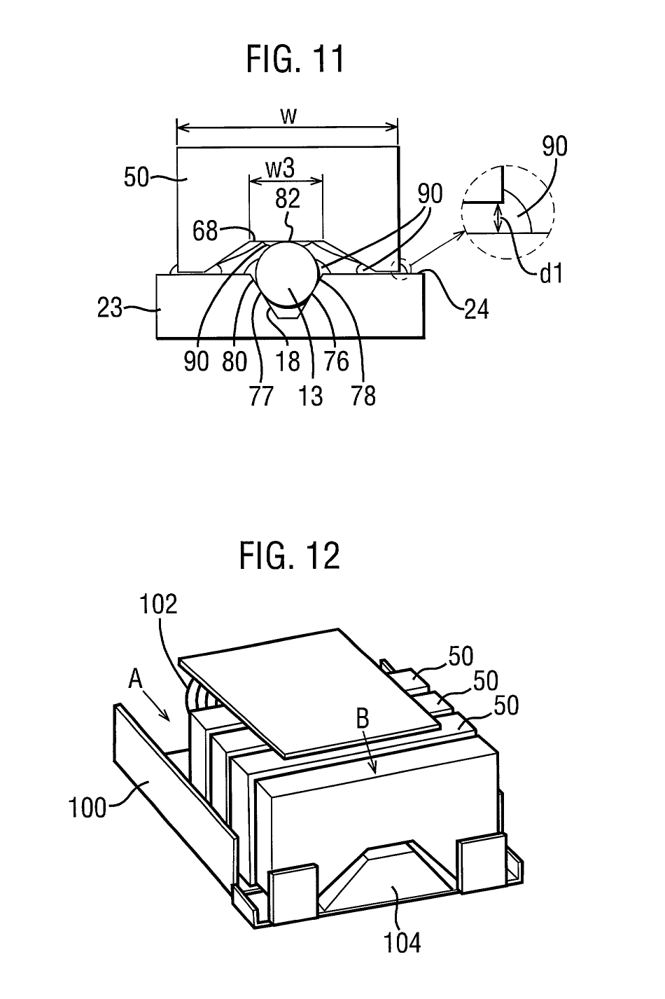

As shown in FIG. 11, it is preferable for the optical fibre 13 to be subject to a 3-point contact with the V-shaped grooves 18, 56 of the substrate 23 and the retainer 50, namely single point contacts 76, 77 with each tapered wall 78, 80 of the V-shaped substrate groove 18 and a single point contact 82 with the base surface 68 of the V-shaped retainer groove 56. To this end, it is preferable if the base surface 68 of the V-shaped groove 56 of the retainer 50 has a width w3 which is at least as great as the width w2 of the V-shaped substrate groove 18. This allows for tolerances in the placement of the retainer 50 on the substrate 23 while still obtaining the preferred 3-point contact on the optical fibre 13.

Alternatively, the V-shaped retainer groove 56 may be so sized with respect to the V-shaped substrate groove 18 to provide for a 4-point contact on the optical fibre 13, namely the single point contacts 76, 77 as before and two single point contacts with the respective flanks 74 of the V-shaped retainer groove 56.

As further shown in FIG. 11, the optical fibre 13 and the first section 70 of the retainer 50 are secured to the silicon substrate 23 and to one another through an adhesive 90, preferably an epoxy resin adhesive. As shown in the inset of FIG. 11, the adhesive 90 may space the underside 54 of the retainer 50 from the upper surface 24 of the substrate by a distance d1, for example 10-15 μm.

Referring to FIGS. 9 to 11, the retainer 50 may have the following dimensions:

A width w in the range of substantially 1000-1500 μm, preferably substantially 1400 μm.

A height h in the range of substantially 500-550 μm.

A width w1 for the V-shaped groove 56 in the range of substantially 250-350 μm, preferably substantially 300 μm.

A width w3 for the base surface 68 of the V-shaped groove 56 of substantially 140-170 μm.

These dimensions for the retainer 50 compare with the following preferred dimensions for the substrate 23:

A substrate height in the range of substantially 500-550 μm.

A substrate length of substantially 16 mm.

A substrate width of substantially 2 mm.

In FIG. 12 there is shown a cartridge 100 containing a series of the retainers 50 for use with a pick-and-place machine. The retainers 50 are biased forwardly in the direction of arrow A by a spring 102. This positions the forwardmost retainer 50 on a sponge 104 against which is it pressed in the direction of arrow B. The sponge 104 has a complementary profile to the underside 54 of the retainer 50 and is impregnated with adhesive. The underside 54 and V-shaped groove 56 of the retainer 50 are therefore coated with the adhesive impregnated in the sponge 104. The pick-and-place machine then transfers the forwardmost retainer 50 from he cartridge 100 onto the substrate 23 in the manner shown in FIGS. 10 and 10A to form the arrangement shown in FIGS. 9 and 11. As will be realised, the adhesive 90 is applied to the V-shaped groove 18 of the substrate 23 prior to the pick-and-place machine transferring the retainer 50 onto the substrate 23.

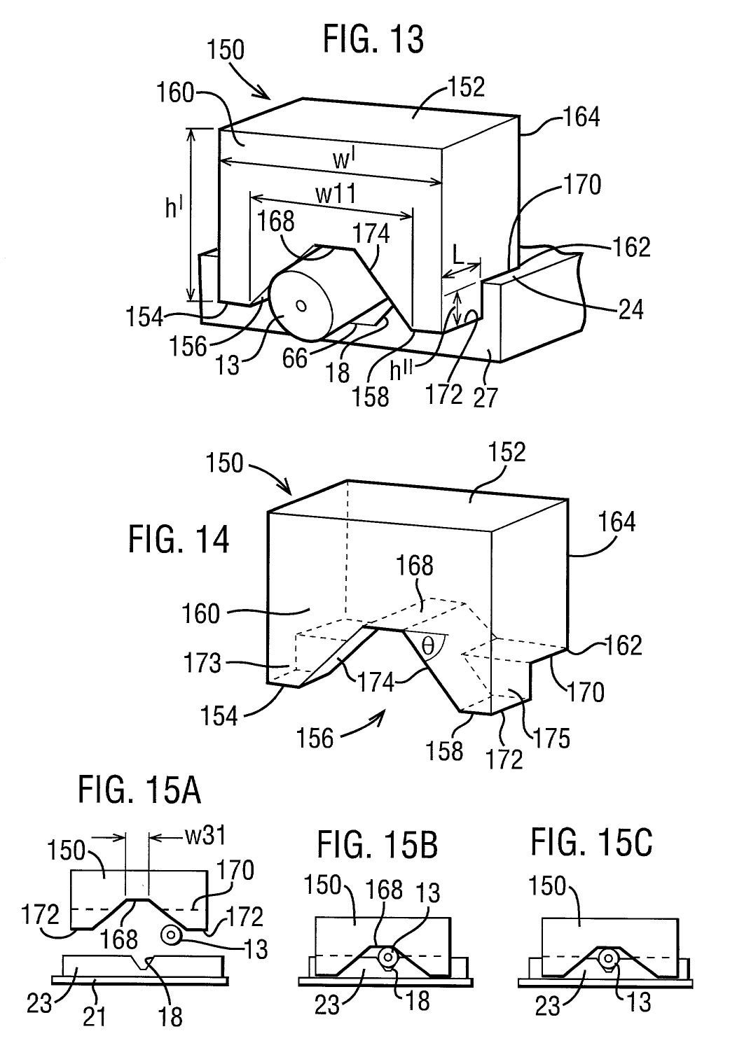

Attention is now turned to FIGS. 13 and 14 which show a further retainer 150 in accordance with the present invention for retaining the optical fibre 13 in the V-shaped groove 18 of the substrate 23. The retainer 150 is in the form of a block 152 having an underside 154 in the surface of which is formed a groove 156 having a uniform V-shaped cross section. The V-shaped groove 156 extends from an edge 158 between the underside 154 and a first side 160 to an opposed edge 162 between the underside 154 and a second side 164. The V-shaped groove 156 of the retainer 150 has a base surface 168.

A first section 170 of the surface of the underside 154 is secured to the upper surface 24 of the silicon substrate 23 so that the respective V-shaped grooves 18, 156 are in registration with one another with the optical fibre 13 captured therebetween. The optical fibre 13 is secured to the V-shaped substrate groove 18 by an adhesive, for example an epoxy resin adhesive. A second section 172 of the surface of the underside 154 overhangs the upper surface 24 of the silicon substrate 23. The second section 172 is stepped from the first section 170 so that, in addition to overhanging the substrate upper surface 24, the second section 172 extends down the side 27 of the substrate 23. In this way, the retainer 150 is formed with two fingers 173, 175 on either side of the section of the V-shaped groove 156 in the second section 172 of the underside 154.

The retainer 150 has many attributes in common with the retainer 50 shown in FIGS. 9 to 11. The retainer 150 acts to oppose forces which tend to peel the optical fibre 13 out of the V-shaped groove 18 in the silicon substrate 23, it is easier to place on the silicon substrate 23 than the retainer made known in U.S. Pat. No. 6,078,711 supra, and, as shown in FIGS. 15A-C, it can be used to guide the optical fibre 13 into the V-shaped groove 18 in the silicon substrate 23.

In connection with the latter point, and referring to FIGS. 15A-C, as a pick-and-place machine (not shown) lowers the retainer 150 towards the substrate 23 the slanted sides 174 of the V-shaped groove 156 tend to centre the optical fibre 13 into the V-shaped groove 156 for the same reasons described for the retainer 50 with reference to FIGS. 10 and 10A.

However, an advantage of the retainer 150 over the retainer 50 of FIGS. 9 to 11 is that the stepping of the overhanging second section 172 from the seating first section 170 means that the optical fibre 13 is in contact with the section of the V-shaped groove 156 in the overhanging second section 172 for a greater period of time during displacement of the retainer 150 onto the substrate 23. This gives more time for the optical fibre 13 to be centred in the V-shaped groove 156 and reduces the risk of clamping of the optical fibre 13 between the upper surface 24 of the substrate 23 and the underside 154 of the retainer 150. Moreover, the stepped profile of the underside 154 means that the section of the V-shaped groove 156 in the overhanging second section 172 has a width w11 which is greater than that of the section of the V-shaped groove 156 in the seating first section 170. This allows greater tolerances in the placement of the optical fibre 13 vis-a-vis the V-shaped groove 18 in the substrate 23, as illustrated in FIG. 15A.

The base surface 168 of the V-shaped groove 156 in the retainer 150 should be wide enough to (i) secure a 3-point contact on the optical fibre 13, as discussed hereinabove with reference to the retainer 50 of FIGS. 9 to 11, and (ii) cover tolerances of the pick-and-place machine and in the manufacture of the retainer 150.

Point (ii) is illustrated in FIG. 15B where it can be seen that the V-shaped groove 156 of the retainer 150 is not centred over the V-shaped groove 18 of the substrate 23. Nevertheless, the width of the base surface 168 is sufficiently great that there is an overlap of the base surface 168 with the V-shaped groove 18 in the substrate 23 so that the only point contact between the retainer 150 and the optical fibre 13 is made with the base surface 168. Thus, the optimal 3-point contact on the optical fibre 13 is obtained. In this connection, it is preferable that the base surface 168 have a width which is at least as great as the width of the V-shaped groove 18 in the substrate 23.

As an alternative, the V-shaped retainer groove 156 may be sized to provide a 4-point contact on the optical fibre 13 with the V-shaped substrate groove 18, as detailed with reference to the retainer 50 of FIGS. 9 to 11.

FIG. 15C shows the ideal position of the retainer 150 on the substrate 23, namely with the respective V-shaped grooves 18, 156 centred with one another.

As shown in FIGS. 15A-C, the fingers 173, 175 are sized so as to be spaced from the insulator 21 when mounted on the silicon substrate 23. However, as will be understood by the reader skilled in the art, the fingers 173, 175 may be sized to contact the insulator 23 when mounted to the substrate 23.

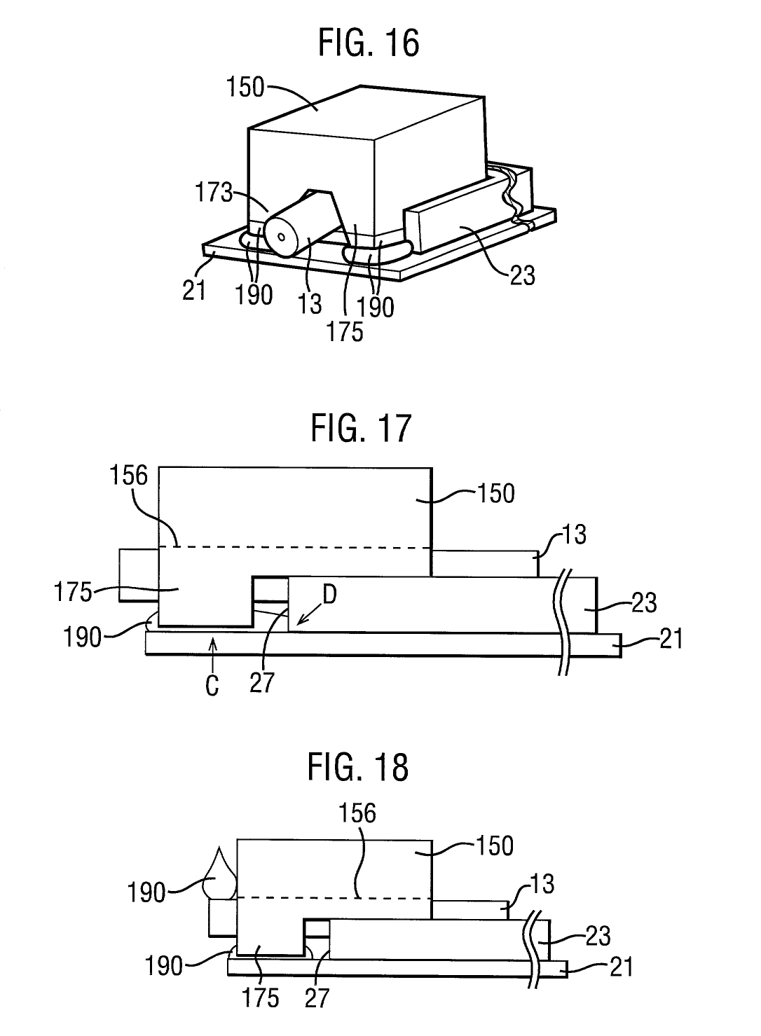

The fingers 173, 175 of the retainer 150 have the advantage that the pick-and-place machine can dip the retainer 150 partially into adhesive before placing it on the substrate 23. As shown in FIG. 16, the adhesive 190 applied to the fingers 173, 175 in this manner secures the fingers 173, 175 to the ceramic insulator 21 on which the silicon substrate 23 is mounted. As an alternative, or in addition, the adhesive 190 may be placed on the insulator 21, and optionally the upper surface 24 of the substrate 23, before placing the retainer 150. A further alternative would be to solely join the retainer 150 to the substrate 23 by placing high viscosity adhesive, preferably epoxy adhesive, on at least one of them before placement.

As will be understood by reference to FIG. 17, it is not necessary for the retainer 150 to abut against the side 27 of the substrate 23. A gap between the fingers 173, 175 and the side 27 of up to 100 μm is acceptable and, in fact, would act as a reservoir for the adhesive 190 if it has a suitable viscosity, as in the case of an epoxy resin adhesive. The retainer 150 would therefore be joined to the ceramic insulator 21 at location C and to the side 27 of the substrate 23 at location D.

As shown in FIG. 18, adhesive 190 can be applied to the optical fibre 13 after it has been captured between the respective V-grooves 18, 156 whereupon it will emerge between the fingers 173, 175 and the ceramic insulator 21 and, if the viscosity of the adhesive is suitable, the fingers 173, 175 and the side 27 of the substrate 23. This can be the sole mechanism for adhesion of the fingers 173, 175 to the ceramic insulator 21/substrate 23 or in addition to one of the other mechanisms described with reference to FIGS. 16 and 17.

As will be understood by the skilled reader in the art, a series of retainers 150 can be loaded in a cartridge in similar fashion to that shown in FIG. 12, the cartridge optionally including an adhesive-impregnated sponge.

Referring back to FIGS. 13 to 15, the retainer 150 may have the following dimensions:

A width w′ in the range of substantially 1000-1500 μm, preferably substantially 1400 μm.

A height h′ in the range of substantially 500-550 μm.

A width for the V-shaped groove 156 at the first section 170 of the underside 154 in the range of substantially 250-350 μm, preferably substantially 300 μm.

A width w11 for the V-shaped groove 156 at the underside 154 of the second section 172 in the range of substantially 500-1000 μm, preferably substantially 800 μm.

A width w31 for the base surface 168 of the V-shaped groove 156 in the range of substantially 140-170 μm.

A length I for the second section 172 of substantially 500 μm.

A height h″ for the step between the first and second sections 170, 172 which is equal to, or less than, the height of the substrate 23, e.g. no more than substantially 500-550 μm.

As can be seen, the retainer 150 may only differ dimensionally from the retainer 50 of FIGS. 9 to 11 by the presence of the fingers 173,175.

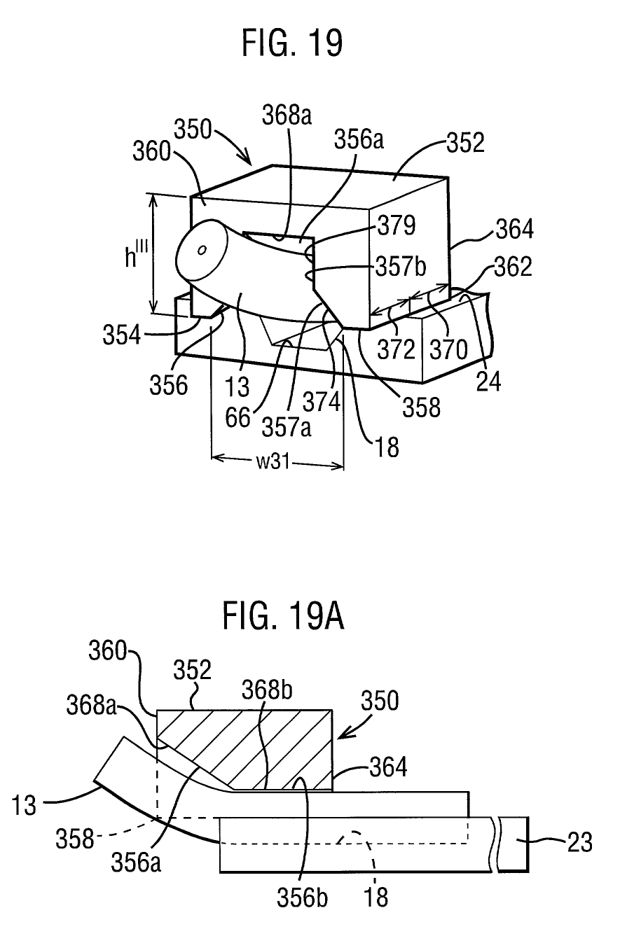

In FIGS. 19 to 21 there is shown a yet further retainer 350 for retaining the optical fibre 13 in the V-shaped groove 18 in the silicon substrate 23. The retainer 350 corresponds to the retainer of FIGS. 9 to 11 except in the geometry of the groove 356.

As will be gathered from FIGS. 19 and 19A, the groove 356 extends from a first edge 358 between the underside 354 and a first side 360 and an opposed second edge 362 between the underside 354 and a second side 364. The retainer groove 356 consists of two sections, a first section 356a which extends inwardly from the first edge 358 and a second section 356b which extends from the first section 356a to the second edge 362.

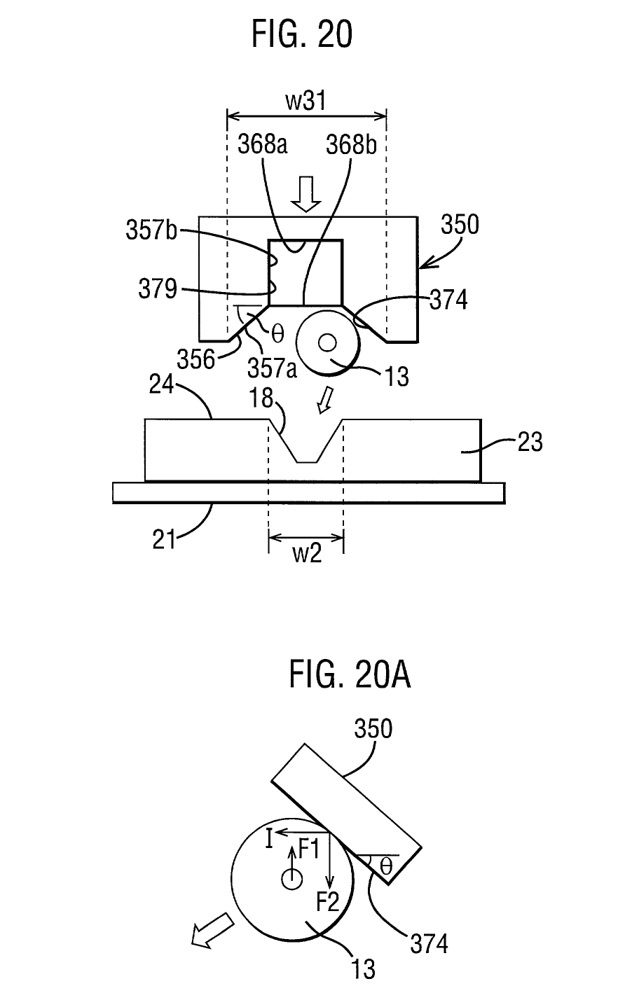

Referring to FIGS. 19 and 20, the first section 356a of the retainer groove 356 has a funnel-shaped cross section comprising a V-shaped mouth portion 357a defined by tapered sidewalls 374 and a U-shaped base portion 357b defined by vertical sidewalls 379 and a planar base surface 368a. The second section 356b has a V-shaped cross section defined by the tapered sidewalls 374 and a planar base surface 368b.

As will be understood from FIGS. 19, 19A and 20, the tapered sidewalls 374 are common to both the first and second sections 356a, 356b of the retainer groove 356. It follows that the retainer groove 356 has a uniform V-shaped cross section immediately adjacent the surface of the underside 354 of the retainer 350, with the width w31 of the retainer groove 356 at the underside 354 being constant along its length. The additional U-shaped base portion 357b of the first section 356a of the retainer groove 356 means the first section 356a has a greater depth than the second section 356b, as shown in FIG. 19A, for example.

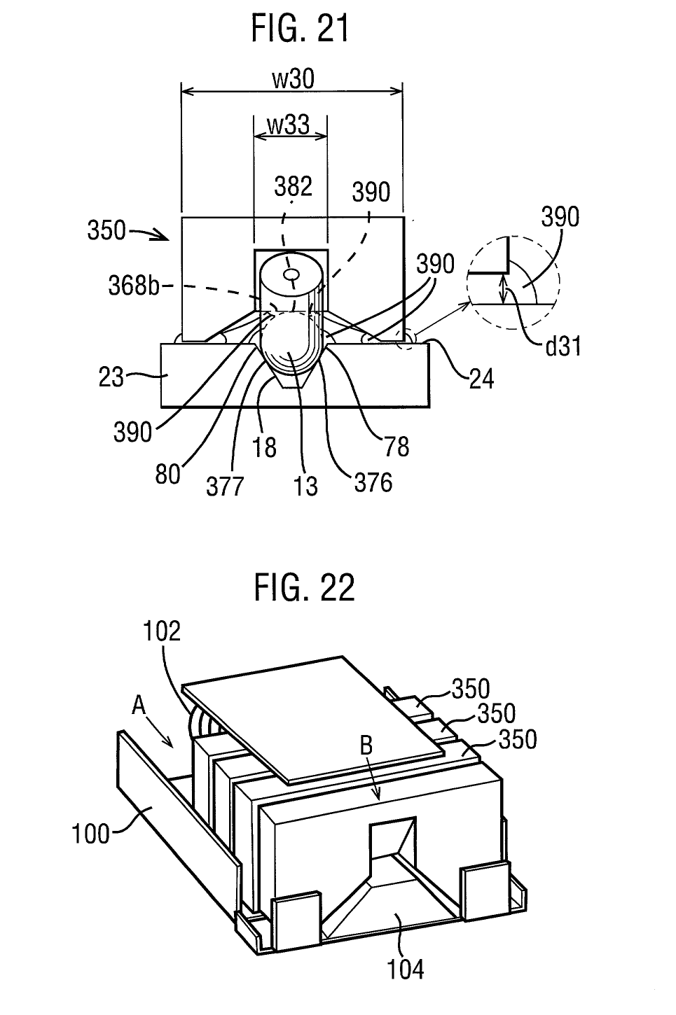

As further shown in FIG. 19A, the base surface 368a of the first section 356a of the retainer groove 356 slopes downwardly from the first edge 358 to the base surface 368b of the second section 356b of the retainer groove 356. As clearly shown in FIG. 21, the width w33 of the U-shaped base portion 357b of the first section 356a of the retainer groove 356 is greater than the diameter of the optical fibre 13, the reason for which will become apparent shortly.

In use, a first section 370 of the surface of the underside 354 having the second section 356b of the retainer groove 356 is secured to the upper surface 24 of the silicon substrate 23 so that the respective V-shaped grooves 18, 356b are in registration with one another with the optical fibre 13 captured therebetween. A second section 372 of the surface of the underside 354 having the first section 356a of the retainer groove 356 overhangs the upper surface 24 of the silicon substrate 23.

The retainer 350 has the same advantages and functions as the retainer 50 of FIGS. 9 to 11, but the greater depth and sloped base surface 368a of the first section 356a of the retainer groove 356 enables the optical fibre 13 to curve upwardly into the U-shaped base portion 357b to adopt the desired S-bend configuration, as shown in FIGS. 19, 19A and 21.

For the optical fibre 13 to be subject to a 3-point contact with the grooves 18, 356a of the substrate 23 and the retainer 350 (FIG. 21), it is preferable if the base surface 368b of the second section 356b of the retainer groove 356 has a width w33 which is at least as great as the width w2 of the V-shaped substrate groove 18. This allows for tolerances in the placement of the retainer 350 on the substrate 23 while still obtaining the preferred 3-point contact on the optical fibre 13.

If, on the other hand, the retainer groove 356 is so sized with respect to the V-shaped substrate groove 18 to provide for a 4-point contact on the optical fibre 13, the width of the U-shaped base portion 357b would be made greater than the width of the base surface 368b of the second section 356b of the retainer groove 356.

In addition to the U-shaped base portion 357b of the retainer groove 356 providing the retainer 350 with the space to enable the optical fibre 13 to curve upwardly to adopt the S-bend, it can also act as an overflow reservoir for any excess adhesive used. Furthermore, as the planar base surface 368a slopes upwardly any protuberance thereon is unlikely to come into contact with the optical fibre 13 and act as a fulcrum about which the section of the optical fibre 13 in the V-shaped groove 18 of the substrate 23 is biased upwardly out of the V-shaped groove 18.

The retainer 350 may have the same dimensions as the retainer 50 of FIGS. 9 to 11 with the width w33 for the U-shaped base portion 357b being the same as that of the base surface 368b of the V-shaped second section 356b of the retainer groove 356, namely substantially 140-170 μm.

As shown in FIG. 22, a series of the retainers 350 can also be loaded in the cartridge 100 for use with a pick-and-place machine.

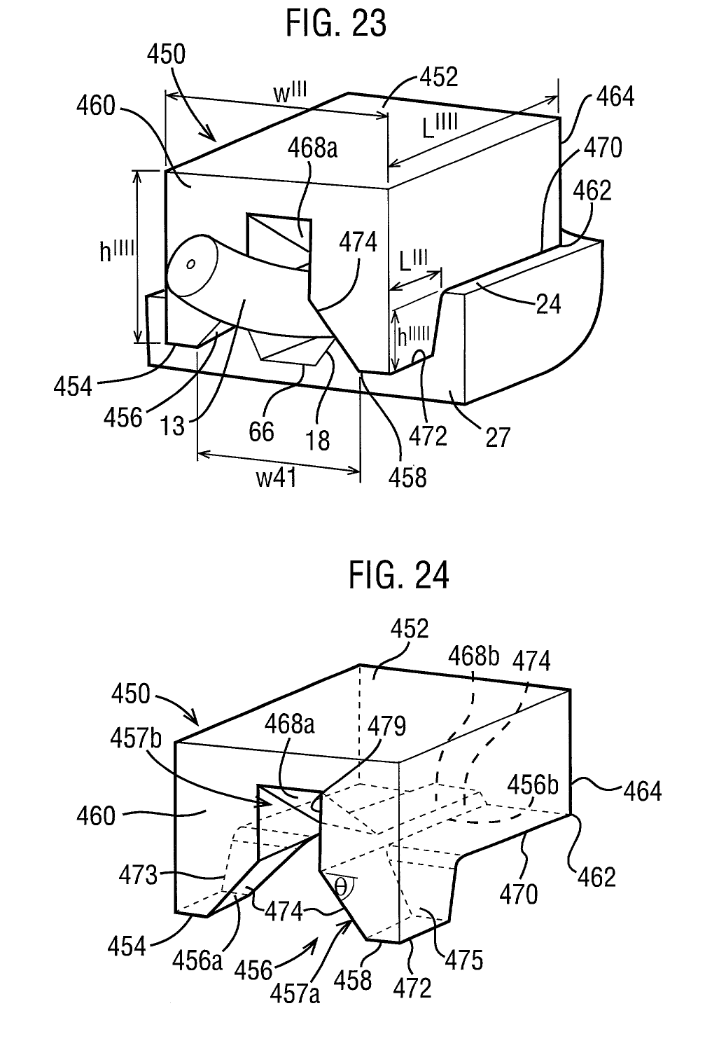

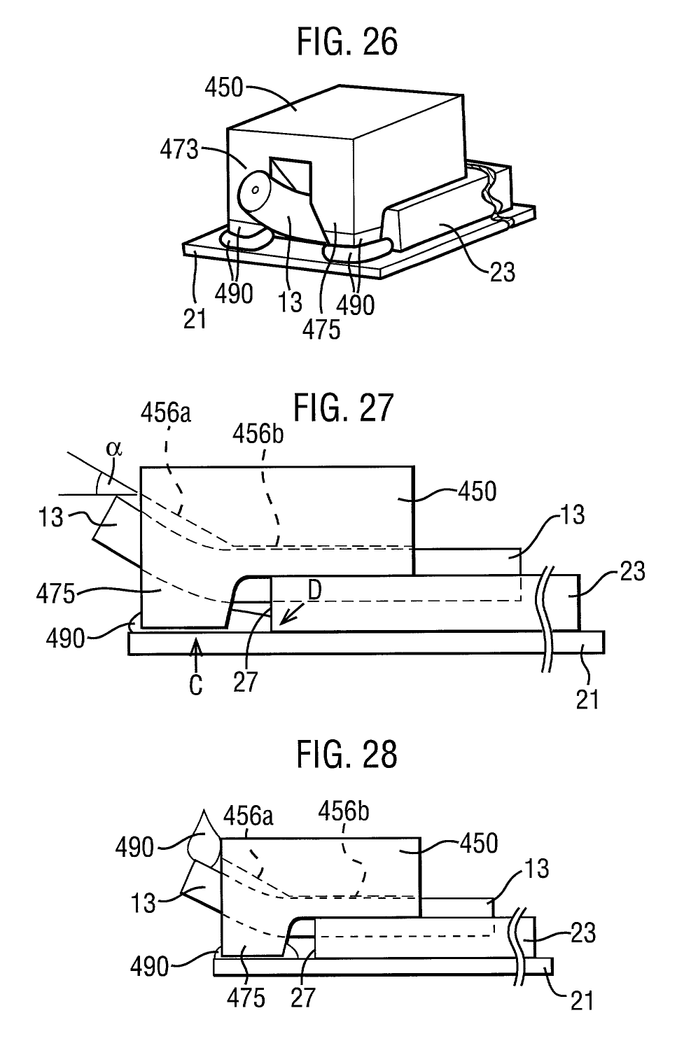

Attention is now turned to FIGS. 23 to 28 which show a further retainer 450 in accordance with the present invention which generally corresponds to the retainer 150 of FIGS. 13 to 18, other than in the geometry of the groove 456 which is similar to the groove 356 of the retainer 350 of FIGS. 19 to 21.

The groove 456 of the retainer 450 consists of two sections, a first section 456a which extends inwardly from the first edge 458 and a second section 456b which extends from the first section 456a to the second edge 462.

The first section 456a of the retainer groove 456 has a funnel-shaped cross section comprising a V-shaped mouth portion 457a defined by tapered sidewalls 474 and a U-shaped base portion 457b defined by vertical sidewalls 479 and a planar base surface 468a. The second section 456b has a V-shaped cross section defined by the tapered sidewalls 474 and a planar base surface 468b.

The planar base surface 468a of the first section 456a of the retainer groove 456 slopes downwardly from the first edge 458 to the planar base surface 468b of the second section 456b of the retainer groove 456. The first section 456a of the retainer groove 456 is thus at a greater depth relative to the depth of the second section 456b, with the depth of the first section 456a increasing continuously in a direction towards the first edge 458.

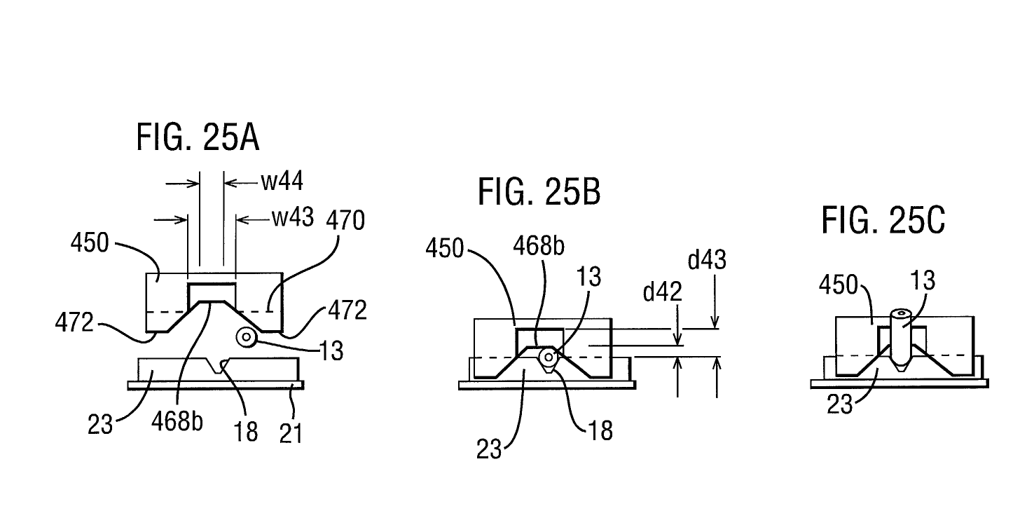

As clearly shown in FIGS. 25A-25C, the width w43 of the U-shaped base portion 457b of the first section 456a of the retainer groove 456 is greater than the diameter of the optical fibre 13. In fact, the width w43 of the U-shaped base portion 457b corresponds to the width of the second section 456b of the retainer groove 456 at the surface of the underside 454, as evident from FIGS. 25A-25C.

In use, a first section 470 of the surface of the underside 454 having the V-shaped second section 456b of the retainer groove 456 is secured to the upper surface 24 of the silicon substrate 23 so that the respective V-shaped grooves 18, 456b are in registration with one another with the optical fibre 13 captured therebetween. The optical fibre 13 is secured to the V-shaped substrate groove 18 by an adhesive, for example an epoxy resin adhesive. A second section 472 of the surface of the underside 454 having the funnel-shaped first section 456a of the retainer groove 456 overhangs the upper surface 24 of the silicon substrate 23. The second section 472 is stepped from the first section 470 so that, in addition to overhanging the substrate upper surface 24, the second section 472 extends down the side 27 of the substrate 23. In this way, the retainer 450 is formed with two fingers 473, 475 on either side of the first section 456a of the retainer groove 456.

The retainer 450 combines the attributes of the retainer 150 of FIGS. 13 to 18 with the attributes of the retainer 350 shown in FIGS. 19 to 21. So, the funnel-shaped first section 456a of the retainer groove 456 accepts an upward curvature of the optical fibre 13 so that the optical fibre 13 can adopt the preferential S-bend configuration. Furthermore, as the planar base surface 468a slopes upwardly any protuberance thereon is unlikely to act as a fulcrum which tends to bias the optical fibre 13 upwardly out of the V-shaped substrate groove 18, as outlined above in connection with the retainer 350 of FIGS. 19 to 21. Furthermore, as shown in FIGS. 25A-C, the retainer 450 can be used to guide the optical fibre 13 into the V-shaped groove 18 in the silicon substrate 23 with the advantages resulting from the fingers 473, 475 discussed with reference to the retainer 150 of FIGS. 13 to 18. The U-shaped base portion 457b of the first section 456a of the retainer groove 456 can also act as an overflow reservoir for excess adhesive.

As will be understood by the skilled reader in the art, a series of retainers 450 can be loaded in a cartridge in similar fashion to that shown in FIG. 12, the cartridge optionally including an adhesive-impregnated sponge.

The retainer 450 may have the following dimensions:

A width w′41 in the range of substantially 1500-2000 μm, preferably substantially 1700 μm.

A height h″″ in the range of substantially 1500-2000 μm, preferably substantially 1800 μm.

A width w43 for the U-shaped base portion 457b, and the V-shaped second section 456b of the groove 456 at the surface of the underside 454, in the range of substantially 150-250 μm, preferably substantially 200 μm.

A width w41 for the first section 456a of the groove 456 at the surface of the underside 454 in the range of substantially 500-1000 μm, preferably substantially 800 μm.

A width w44 for the base surface 468b of the V-shaped second section 456b of the groove 456 in the range of substantially 140-170 μm.

A length I′″ for the second section 472 of substantially 500 μm.

A height h′″″ for the step between the first and second sections 470, 472 which is equal to, or less than, the height of the substrate 23, e.g. no more than substantially 500-550 μm, preferably substantially 450 μm.

A total length I″″ of substantially 2250 μm.

A depth d42 for the second section 456b of the groove 456 of substantially 60 μm.

A depth d43 for the U-shaped base portion 457b of substantially 500 μm.

An angle α of inclination for the planar base surface 468a of the first section 456a of the groove 456 with respect to a plane parallel to the underside 454 of between 25-35°, preferably substantially 30°.

The retainers 50-450 herein described are preferably made from a material which is transparent to ultraviolet (UV) radiation whereby the adhesive 90-490 can be set or cured by UV radiation after the retainers have been placed on the substrate. As an example, there may be mentioned ceramic materials, such as the glass ceramic MACOR™ (The Technical Glass Company) and alumina (The Technical Glass Company), and plastics materials, such as an acrylic plastics material, preferably a polymethyl methacrylate (PMMA) and more preferably Perspex™. The retainers 50-450 may be formed from a ceramic material by machining, laser cutting, injection moulding or sintering. Use of a ceramic material has the added advantage of enabling use of the so-called “blue light cure system” in which blue light is used in place of UV radiation, as this leads to a maximum duration of 30 seconds for permanent curing of the adhesive. Injection moulding would be the preferred process for manufacturing plastic retainers 50-450.

For the retainers 50-450 herein described, increasing the angle θ of the tapered sidewalls 74-474 of the V-shaped grooves 56-456 (see FIGS. 10, 14, 20 and 24) reduces the risk of clamping of the optical fibre 13 between the underside 54-454 of the retainer 50-450 and the substrate upper surface 24. Preferably, the angle θ of the tapered sidewalls 74-474 is in the range of substantially 40-50°.

It will be understood that the retainers 50-450 herein described may be provided with more than one V-shaped groove 56-456 so that a plurality of optical fibres 13 can be mounted to the substrate 23, i.e. one groove 56-456 per optical fibre 13. The substrate 23 may be provided with a corresponding number of V-shaped grooves 18.

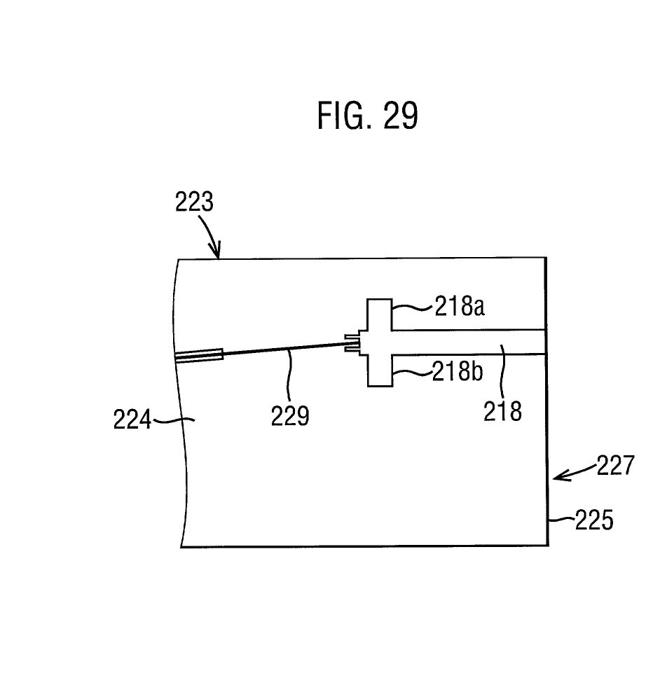

Reference will now be made to FIG. 29 which shows a silicon substrate 223 of an optical chip in accordance with the present invention. The silicon substrate 223 has an upper surface 224 along which a V-shaped channel 218 extends from an edge 225 between the upper surface 223 and a side surface 227. An optical waveguide 229 terminates in a diving board arrangement at the end of the V-shaped groove 218. Adjacent the end of the V-shaped groove 218 are formed a pair of lateral V-shaped grooves 218a, 218b on opposing sides of the V-shaped groove 218. The lateral grooves 218a, 218b each communicate with the V-shaped groove 218. The purpose of the lateral grooves 218a, 218b is to provide an overflow reservoir for excess adhesive used for securing the optical fibre 13 and/or the retainer 50, 150 to the substrate 223. As importantly, the lateral grooves 218a, 218b enable the flare of the optical fibre 13 caused by cleaving, and laser cleaving in particular, to be accommodated outside of the main V-shaped groove 218 so that the optical fibre can sit straight and flat in the main V-shaped groove 218.

As will be seen, the present invention provides various means for improving the mounting of an optical fibre to a substrate of an optical chip thereby improving the optical coupling of the optical fibre to circuit elements on the optical chip.

It will be understood by the skilled reader in the art that the present invention is not limited to the exemplary embodiments which have been described with reference to the accompanying Figures of drawings but may be varied in many different ways within the scope of the appended claims. For instance, the invention in some of its aspects is not restricted to the field of opto-electronics. In addition, the groove in the retainer may be of any tapered cross-section, e.g. curvilinear. Moreover, the retainer may have more than one groove so as to be able to mount a plurality of optical fibres to an optical chip.

1. A retainer for retaining a first section of an elongate element of generally curvilinear cross section in a mounting channel which extends along a surface of a first side of a substrate from an edge at which a second side of the substrate inclines away from the first side in a first direction, the retainer having:
a mounting surface adapted in use to be mounted on the surface of the first side of the substrate;
a first retaining channel formed in the mounting surface adapted in use to cover the first section of the elongate element in the mounting channel;
an overhanging surface adapted in use to overhang the edge of the first side of the substrate, the overhanging surface being displaced, in use, in the first direction relative to the mounting surface; and
a second retaining channel formed in the overhanging surface adapted in use to be positioned about a second section of the elongate element which projects from the mounting channel.

2. A retainer for retaining a first section of an elongate element of generally curvilinear cross section in a mounting channel which extends along a surface of a first side of a substrate from an edge at which a second side of the substrate inclines away from the first side in a first direction, the retainer having:
a mounting surface adapted in use to be mounted on the surface of the first side of the substrate;
a first retaining channel having a first width formed in the mounting surface adapted in use to cover the first section of the elongate element in the mounting channel;
an overhanging surface adapted in use to overhang the edge of the first side of the substrate, the overhanging surface being displaced, in use, in the first direction relative to the mounting surface; and
a second retaining channel formed in the overhanging surface adapted in use to be positioned about a second section of the elongate element which projects from the mounting channel, the second channel having a second width greater than the first width and tapered sidewalls which, in use, diverge in the first direction.

3. A retainer according to claim 1 or 2 having a first side of which the mounting and overhanging surfaces form sections and a second side at an edge of the first side, the section of the first side formed by the overhanging surface and the second retaining channel extending inwardly from the edge of the first side of the retainer.

4. A retainer according to claim 3, wherein the first and second retaining channels form sections of a channel which extends along the surface of the first side of the retainer from the edge thereof.

5. A retainer according to claim 1 or 2 having a first side of which the mounting and overhanging surfaces form sections and a second side at an edge of the first side, the first and second retaining channels forming sections of a channel which extends along the first side of the retainer from the edge thereof.

6. A retainer according to claim 1 or 2, wherein the mounting and overhanging surfaces form contiguous sections of a side of the retainer.

7. A retainer according to claim 4, wherein the edge of the first side of the retainer is a first edge, the first side of the retainer has a second edge between the first side and a third side and the channel extends from the first edge to the second edge.

8. A retainer according to claim 7, wherein the section of the first side formed by the mounting surface extends inwardly from the second edge.

9. A retainer according to claim 3, wherein the channel in the first side of the retainer consists of the first and second retaining channels.

10. A retainer according to claim 1 or 2, wherein the first and second retaining channels have tapered sidewalls which, in use, diverge in the first direction.

11. A retainer according to claim 10, wherein the tapered sidewalls are connected by a base wall which extends laterally to the sidewalls.

12. A retainer according to claim 1 or 2, wherein the first and second retaining channels have a V-shaped cross section.

13. A retainer according to claim 1 or 2, wherein the retainer is formed from a material which is transparent to ultraviolet radiation.

14. A retainer for retaining a flexible elongate element of generally curvilinear cross section in a mounting channel extending along an upper surface of a substrate, the retainer having a lower surface along which a retaining channel extends in a forward direction from a rear edge of the lower surface, wherein, in use, the lower surface is juxtaposed with the substrate upper surface to retain the elongate element in the mounting channel and to align the respective channels, wherein the elongate element is receivable upwardly in the retaining channel to rest on a contact area which, at the rear edge, is spaced upward of the lower surface at a first level and extends downwardly from the rear edge towards the lower surface in the forward direction whereby, in use, the elongate element is able to be angled upwardly from the mounting channel through the retaining channel.

15. A retainer according to claim 14, wherein the contact area extends downwardly towards the lower surface monotonically.

16. A retainer according to claim 14, wherein the retaining channel has sidewalls which converge from the lower surface in the upward direction

17. A retainer according to claim 14, wherein the retaining channel has a bottom which is the contact area.

18. A retainer according to claim 17, wherein the bottom is planar.

19. A retainer according to claim 14 or 15, wherein, from the lower surface to the contact area, the retaining channel has a minimum lateral width which is at least as great as a diameter of the elongate element.

20. A retainer according to claim 14, wherein the retaining channel is a rear section of a retaining channel structure further having a forward section which, in use, is co-extensive with the mounting channel, wherein the forward section has a contact area for the elongate element spaced upwardly from the lower surface at a second level which is spaced downwardly relative to the first level, and wherein the rear section extends forwardly from the rear edge to a forward position at which the contact area is spaced upwardly from the lower surface at a third level which is spaced downwardly relative to the first level no lower than the second level.

21. A retainer according to claim 20, wherein the second and third levels are at the same level.

22. A retainer according to claim 20, wherein the forward and rear sections are contiguous at the forward position.

23. A retainer according to claim 20, wherein the forward section has a bottom which forms its contact area.

24. A retainer according to claim 20, wherein the forward section has sidewalls which converge from the lower surface in the upward direction.

25. A retainer according to claim 14, wherein the retaining channel has parallel sidewalls extending downwardly from its bottom to give a generally U-shaped cross section.

26. A retainer according to claims 16 and 25, wherein the convergent sidewalls are lower sidewalls and the parallel sidewalls are upper sidewalls and wherein the upper and lower sidewalls are contiguous to give the retaining channel a funnel-like cross section.

27. A retainer according to claim 20, wherein the rear section has a lower portion extending upwardly from the lower surface to a level located upwardly of the second level and wherein the lower portion has a minimum lateral width which is at least equal to a lateral width of the forward section at the lower surface.

28. A retainer according to claim 20, wherein the rear section has a minimum lateral width which is at least equal to a lateral width of the forward section at the lower surface.

29. A retainer according to claim 27 or 28, wherein the minimum lateral width of the rear section is at its bottom.

30. A retainer according to claim 20, wherein the rear and forward sections of the retainer channel structure are respectively formed in rear and forward sections of the lower surface, the rear section of the lower surface being displaced downwardly relative to the forward section of the lower surface whereby, in use, the forward section of the lower surface is juxtaposed with the substrate upper surface with the rear section of the lower surface overhanging the substrate upper surface.

31. A retainer according to claim 30, wherein the rear and forward sections of the lower surface are contiguous.

32. A retainer according to claim 20, wherein the lower surface has a forward edge and the retaining channel structure extends from the rear edge to the forward edge.

33. A retainer according to claims 30 and 32, wherein the forward section of the lower surface extends rearwardly from the forward edge.

34. A retainer according to claim 20, wherein the retaining channel structure consists of the rear and forward sections.

35. A retainer according to claim 14 or 15, wherein the retainer is formed from a material which is transparent to ultraviolet radiation.

36. An assembly having a substrate having a first side with a surface in which is formed a mounting channel which extends from an edge at which a second side of the substrate is inclined away from the first side in a first direction, an elongate element of generally curvilinear cross section having a first section disposed in the mounting channel and a second section projecting from the mounting channel, and a retainer according to claim 1 or 2, wherein the mounting surface of the retainer is apposed to the first side of the substrate so that the first section of the elongate member is covered by the first retaining channel and the overhanging surface of the retainer overhangs the edge of the first side of the substrate and is displaced in the first direction relative to the mounting surface with the second retaining channel being disposed about the second section of the elongate element.

37. An assembly according to claim 36, wherein the elongate member is an optical fibre and the substrate is a part of an optical chip.

38. An assembly according to claim 36, wherein the width of at least the second retaining channel is greater than the width of the mounting channel.

39. An assembly according to claim 36, wherein the first and second retaining channels have tapered sidewalls which, in use, diverge in the first direction, wherein the tapered sidewalls are connected by a base wall which extends laterally to the sidewalls and wherein the width of the base wall of at least the second retaining channel is greater than the width of the mounting channel.

40. An assembly having a substrate having an upper surface with rear and forward edges in which is formed a mounting channel having a forward end and a rear end, an elongate element of generally curvilinear cross section having a forward section disposed in the mounting channel and a rear section projecting rearwardly from the mounting channel, and a retainer having a lower surface with rear and forward edges in which a retaining channel extends forwardly from the rear edge, the retainer being arranged relative to the substrate so that the lower surface thereof is juxtaposed with the substrate upper surface to cover the mounting channel to retain the forward section of the elongate element therein and that the rear section of the elongate element projects rearwardly upwardly from the mounting channel through the retaining channel.

41. An assembly according to claim 40, wherein the retaining channel is a rear section of a retaining channel structure which further has a forward section which overlies the forward section of the elongate element.

42. An assembly according to claim 41, wherein the forward and rear sections of the retaining channel structure each have a bottom at a level spaced upwardly from the lower surface with the bottom of the forward section being at a lower level relative to the level of the bottom of the rear section.

43. An assembly according to claim 40, 41 or 42 in which the retainer is a retainer according to claim 14.

44. An assembly according to claim 40 in which the elongate element is an optical fibre.

45. An assembly according to claim 40 in which the mounting channel extends forwardly from the rear edge of the upper surface of the substrate.

46. An assembly according to claim 45 in which the rear edge of the lower surface of the retainer overhangs the rear edge of the upper surface of the substrate.

47. An assembly according to claim 40 further having a package having an outer casing, an interior cavity and an inlet through the outer casing to the interior cavity, wherein the substrate is located in the interior cavity such that the upper surface thereof is located downwardly relative to the inlet and wherein the elongate element projects through the inlet.

48. A method of guiding an elongate element of generally curvilinear cross section into a mounting channel which extends along a surface of a first side of a substrate from an edge at which a second side of the substrate inclines away from the first side in a first direction having the steps of:
providing a retainer according to claim 1 in which at least the second retaining channel has tapered sidewalls and the mounting and overhanging surfaces form mounting and overhanging sections of a side of the retainer;
positioning the retainer, the substrate and the elongate element relative to one another such that the first and second retaining channels face the mounting channel with the elongate element disposed between the side of the retainer and the first side of the substrate; and
effecting relative displacement between the retainer and the substrate so that the elongate element is positioned in the mounting channel with:
the mounting section apposed to the first side of the substrate,
the overhanging section overhanging the edge between the first and second sides of the substrate, and
the first and second retaining channels covering the elongate element.

49. A method of guiding an elongate element of generally curvilinear cross section into a mounting channel which extends along a surface of a first side of a substrate from an edge at which a second side of the substrate inclines away from the first side in a first direction having the steps of:
providing a retainer according to claim 2 in which the mounting and overhanging surfaces form mounting and overhanging sections of a side of the retainer;
positioning the retainer, the substrate and the elongate element relative to one another such that the first and second retaining channels face the mounting channel with the elongate element disposed between the side of the retainer and the first side of the substrate; and
effecting relative displacement between the retainer and the substrate so that the elongate element is positioned in the mounting channel with:
the mounting section apposed to the first side of the substrate,
the overhanging section overhanging the edge between the first and second sides of the substrate, and
the first and second retaining channels covering the elongate element.

50. A method according to claim 48 or 49, wherein the retainer, the substrate and the elongate element are positioned relative to one another such that the elongate element is positioned on an axial path between the first and second retaining channels and the mounting channel and the relative displacement between the retainer and the substrate is along the axial path.

51. A method according to claim 50, wherein the relative positioning of the retainer, the substrate and the elongate element is such that the first and second retaining channels are in registration with the mounting channel.

52. A method according to claim 48 or 49, wherein the first and second retaining channels have a base wall which extends laterally to the tapered sidewalls and wherein the relative positioning of the retainer, the substrate and the elongate element is such that at least a part of the base wall of the first and second retaining channels overlaps the mounting channel whereby when the elongate element is positioned in the mounting channel it is acted on by the base wall of the first and second retaining channels.

53. A method of guiding an optical fibre into a mounting channel which extends along a surface of an optical chip, the method having the steps of:
providing a guide element having a surface in which there is formed a guide channel having tapered sidewalls;
positioning the guide element, the optical chip and the optical fibre relative to one another such that the guide channel faces the mounting channel with the optical fibre disposed between the surfaces of the guide element and the optical chip; and
effecting relative displacement between the guide element and the optical chip so that the optical fibre is guided into the mounting channel by the guide channel.

54. A method according to claim 53, wherein the guide channel has a width which is greater the width of the mounting channel.

55. A method according to claim 53, wherein the guide channel has a base wall which bridges the tapered sidewalls with the width of the base wall being greater than the width of the mounting channel.

56. A method according to claim 53, wherein the guide element, the optical chip and the optical fibre are positioned relative to one another such that the optical fibre is positioned on an axial path between the guide channel and the mounting channel and the relative displacement between the guide element and the optical chip is along the axial path.

57. A method according to 56, wherein the relative positioning of the guide element, the optical chip and the optical fibre is such that the guide channel and mounting channel are in registration with one another.

58. A method according to claim 55 and 56, wherein the relative positioning of the guide element, the optical chip and the optical fibre is such that at least a part of the base wall of the guide channel overlaps the mounting channel whereby when the optical fibre is positioned in the mounting channel it is acted on by the base wall of the guide channel.

59. A method according to claim 53, wherein:
the mounting channel has a depth in a first direction, the surface of the optical chip is of a first side and the mounting channel extends along the surface of the first side from an edge at which a second side of the optical chip is inclined away from the first side in the first direction; and
the guide channel has a depth in a second direction with the surface of the guide element being of a first side and the guide channel extending along the surface of the first side from an edge at which a second side of the guide element is inclined away from the first side in the second direction.

60. A method according to claim 53, wherein the relative movement between the guide element and the optical chip results in a mounting section of the surface of the guide element being brought into apposition with the surface of the optical chip and an overhanging section of the surface of the guide element overhanging the surface of the optical chip.

61. A method according to claim 60, wherein the overhanging section is displaced relative to the mounting section in the direction of movement of the guide element relative to the optical chip.

62. A method according to claim 60 or claim 61 in which the guide channel is disposed in the overhanging section.

63. A method according to claims 59 and 60, wherein the overhanging section is bounded by the edge between the first and second sides of the guide element.

64. A coupling device for coupling an optical fibre to a package for mounting of the optical fibre to an optical chip in the package, the coupling device having:
a body which:
is adapted to be coupled to the package in a coupled position; and
has a passageway in which the optical fibre is positionable in a secured position such that a section of the optical fibre projects from the passageway;
characterized in that:
the body is provided with an indexing feature adapted to co-operate with an indexing feature of an apparatus for cleaving optical fibre whereby cleavage of the section of the optical fibre projecting from the passageway by the apparatus when the respective index features co-operate indexes the length and orientation of the cleaved optical fibre section to the indexing feature on the coupling device.

65. A coupling device according to claim 64, wherein the passageway is an open-ended passageway through which the optical fibre is passable to the secured position.

66. A coupling device according to claim 64 or 65, wherein the indexing feature on the coupling device is a structural feature adapted to engage with the indexing feature on the cleaving apparatus.

67. A coupling device according to claim 66, wherein the indexing feature on the body is a female recess for engaging a male protrusion on the cleavage apparatus.

68. In combination, a coupling device according to claim 64 and an apparatus for cleaving optical fibre having an indexing feature co-operable with the indexing feature of the coupling device.

69. A substrate for an optical chip having a side with a surface in which there is formed a channel for an optical fibre to be mounted in, characterized in that the channel is a first channel and that the surface is provided with a second channel which is oriented transversely to, and in communication with, the first channel.

70. A substrate according to claim 69, wherein the first channel has an end and the second channel is located at least adjacent to the end.

71. A substrate according to claim 69 or 70, wherein the surface is provided with a third channel oriented transversely to, and in communication with, the first channel and the second and third channels are aligned with one another on opposing sides of the first channel.

72. A substrate according to claim 69, wherein the first channel extends into the surface from an edge of the side.

73. An optical chip having a substrate according to claim 69.
